(19) United States
(12) Patent Application Publication
(10) Pub. No.: US 2023/0405683 A1
(43) Pub. Date: Dec. 21, 2023

(54) THREE-DIMENSIONAL PRINTED OBJECTS WITH REGIONS OF DIFFERING POROSITY

(71) Applicant: Hewlett-Packard Development Company, L.P., Spring, TX (US)

(72) Inventors: BEN PON, PALO ALTO, CA (US); JOHN SAMUEL DILIP JANGAM, PALO ALTO, CA (US); CHANDRAKANT DURLABHBHAI PATEL, PALO ALTO, CA (US)

(21) Appl. No.: 18/034,847

(22) PCT Filed: Dec. 1, 2020
(86) PCT No.: PCT/US2020/062737

§ 371 Date: May 1, 2023

(51) Int. Cl. B22F 10/85; B33Y 30/00; B33Y 80/00; B33Y 10/00; B22F 12/90; B22F 10/38; B33Y 50/02; B22F 10/14; B22F 5/10; F28D 15/04; F28D 15/02

(52) U.S. Cl. CPC B22F 10/85; B33Y 30/00; B33Y 80/00; B33Y 10/00; B22F 12/90; B22F 10/38; B33Y 50/02; B22F 10/14; B22F 5/106; F28D 15/046; F28D 15/0283; B22F 2998/10; B22F 2301/10; F28F 2255/18

(57) ABSTRACT

In one example in accordance with the present disclosure, an additive manufacturing system is described. The additive manufacturing system includes an additive manufacturing device to form a three-dimensional (3D) printed object with regions of differing porosity. The additive manufacturing system also includes a controller to form the 3D printed object. Specifically, by controlling ejection of a first binding agent onto a porous region and a non-porous region of the 3D printed object and controlling ejection of a second binding agent onto the non-porous region of the 3D printed object.

### BACKGROUND

Additive manufacturing systems produce three-dimensional (3D) objects by building up layers of material. Some additive manufacturing systems use inkjet or other printing technology to apply some of the manufacturing materials. 3D printing devices and other additive manufacturing devices make it possible to convert a computer-aided design (CAD) model or other digital representation of an object directly into the physical object.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of an additive manufacturing system for forming 3D printed objects with regions of differing porosity, according to an example of the principles described herein.

FIG. 2 is a diagram of an additive manufacturing device for forming 3D printed objects with regions of differing porosity, according to an example of the principles described herein.

FIG. 3 is an example of a 3D printed heat pipe with regions of differing porosity, according to an example of the principles described herein.

FIG. 4 is a flow chart of a method for forming 3D printed objects with regions of differing porosity, according to an example of the principles described herein.

FIG. 5 is an example of a 3D printed vapor chamber with regions of differing porosity, according to an example of the principles described herein.

FIG. 6 is a diagram of a 3D printed object with regions of differing porosity, according to an example of the principles described herein.

FIG. 7 is a diagram of a 3D printed object with regions of differing porosity, according to an example of the principles described herein.

FIG. 8 is a flow chart of a method for forming 3D printed objects with regions of differing porosity, according to an example of the principles described herein.

FIG. 9 depicts a non-transitory machine-readable storage medium for forming 3D printed objects with regions of differing porosity, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Additive manufacturing systems form a three-dimensional (3D) object through the solidification of layers of build material. Additive manufacturing systems make objects based on data in a 3D model of the object generated, for example, with a computer-aided drafting (CAD) computer program product. The model data is processed into slices, each slice defining portions of a layer of build material that are to be solidified.

In one example, to form the 3D object, a build material, which may be powder, is deposited on a bed. A binding agent is then dispensed onto portions of a layer of build material that are to be fused to form a layer of the 3D object. This “latent” part, which refers to the powder build material with binding agent deposited thereon is heated to remove solvents present in the applied binding agent. As solvents are removed, the remaining binding agent hardens and glues together build material to convert the “latent” part into a “green” part. As the part continues to heat, the binding agent decomposes and causes the build material powder particles to sinter together into a durable solid form.

In some cases, metal 3D printed objects may be formed by depositing a metal powder build material and/or a metallic binding agent. In these examples, as the binding agent fuses, a solid metallic 3D printed object may be formed. Accordingly, the present specification describes an additive manufacturing device that forms metal 3D printed objects, and more specifically 3D printed objects with regions of differing porosity. A porous region may act as a filter while a non-porous region may provide a water-tight and/or air tight body.

As a particular example, a heat pipe is a device that transfers heat from a hot region to a cold region by vaporization and condensation of liquid. Heat pipes may include a hollow inner channel used to pass vapors to the cold region. A wicking structure along the inner surface transfers condensate back to the hot region of the heat pipe.

Manufacturing heat pipes may be a complex operation. As a specific example, a heat pipe may be formed of copper with water as the working liquid. The wicking structure may be created via longitudinally arranged fiber bundles, axial grooves or copper pores. Forming the wicking structure relies on an additional operation e.g. copper powder is poured into the pipe around a mandrel and sintered to create wick structure on the inner wall. As such, heat pipes and vapor chambers are formed in simple shapes and geometries, due to the complexity and number of operations involved in the manufacturing processes. Even basic vapor chamber structures are formed of several parts that are welded and adhered together.

Accordingly, the present specification describes the 3D printing, or additive manufacturing, of heat pipes, vapor chambers, and other structures that may have regions that have different porosity. For example, a heat pipe may include a non-porous outer surface that is lined with a porous wicking structure. 3D printing these structures may provide for increased customization in heat pipe and vapor chamber geometries, may enhance the efficiency of the heat exchanger, and/or provide new methods to produce heat pipe parts.

In accordance with the principles described herein, copper green parts were 3D printed using copper nitrate and silver nanoparticle ink. Non-porous walls were formed by printing silver nanoparticles sintered with the copper powder. The wicking structure was formed without printing the silver nanoparticle ink. The entire object was sintered at a low temperature, which caused the silver nanoparticle ink particles to melt and fuse between the copper powder material forming the non-porous regions. By comparison, the temperature was not so great as to sinter the copper powder material into a solid mass, but rather there were still voids present between the copper powder particles.

Accordingly, the present specification describes an additive manufacturing system that applies 1) a first binding agent to portions of a 3D object to be printed to create the non-porous and porous regions and 2) a second binding agent to a second portion of the 3D object to be printed to create a non-porous region in the object. The additive manufacturing system may determine the locations of the non-porous and porous regions based on an indication from a user. In one particular example, the additive manufacturing system may distribute copper powder on the print bed, deliver copper nitrate to the porous regions, and deliver copper nitrate and silver nanoparticles to the non-porous regions. In this particular example, the silver nanoparticles bind copper particles together and create a watertight layer.

In some examples, the additive manufacturing system can achieve a variety of target porosities based on the parameters of the additive manufacturing operation. For example, densities achieved during sintering are a function of particle size, particle size distribution, sintering temperature, and sintering time. Based on the application, different porosities may be desired to allow wicking, vapor transport, and condensation. The present specification allows for the porosity of the wicking structure to be tuned for a particular application by varying of powder size, binder quantity, and sintering cycles. As such, the present additive manufacturing system may create a porous wicking channel surrounded by impervious watertight and airtight walls.

Specifically, the present specification describes an additive manufacturing system. The additive manufacturing system includes an additive manufacturing device to form a three-dimensional (3D) printed object with regions of differing porosity. The additive manufacturing system also includes a controller to form the 3D printed object. This may be done by 1) controlling ejection of a first binding agent on a porous region and a non-porous region of the 3D object to be printed and 2) controlling ejection of a second binding agent on the non-porous region of the 3D printed object.

The present specification also describes a method. According to the method, slices of a 3D printed object with regions of differing porosity are formed by sequentially 1) depositing a powder build material, 2) ejecting a first binding agent onto a porous region and a non-porous region of the 3D printed object, and 3) ejecting a second binding agent on the non-porous region of the 3D printed object. The powder build material is then heated to a temperature greater than the melting temperature of the second binding agent and lower than the build material.

The present specification also describes a non-transitory machine-readable storage medium encoded with instructions executable by a processor. The machine-readable storage medium includes instructions. The instructions, when executed by the processor, cause the processor to 1) determine a porous region of a three-dimensional (3D) object to be printed, 2) determine a target porosity for the porous region; and 3) determine a non-porous region of the 3D object to be printed. The instructions, when executed by the processor, also cause the processor to calculate object forming instructions for an additive manufacturing device to form the 3D object based on the target porosity. The object forming instructions indicate 1) a quantity of a first binding agent to eject in the porous and non-porous region and 2) a quantity of a second binding agent to eject in the non-porous region based on the target porosity. In this example, the first binding agent has a lower melting temperature than the second binding agent. The instructions, when executed by the processor, also cause the processor to pass the object forming instructions to the additive manufacturing device.

Such systems and methods 1) allow for printing of objects such as heat pipes and vapor chambers that have regions of differing porosity; 2) form such objects in a single printing cycle without assembly of a variety of complex components; 3) allow for geometrical customization of the porous region, non-porous region, and overall heat exchanger; and 4) allows for enhanced capillary pressure, capacity, and boiling performance through customized geometries. However, it is contemplated that the systems and methods disclosed herein may address other matters and deficiencies in a number of technical areas.

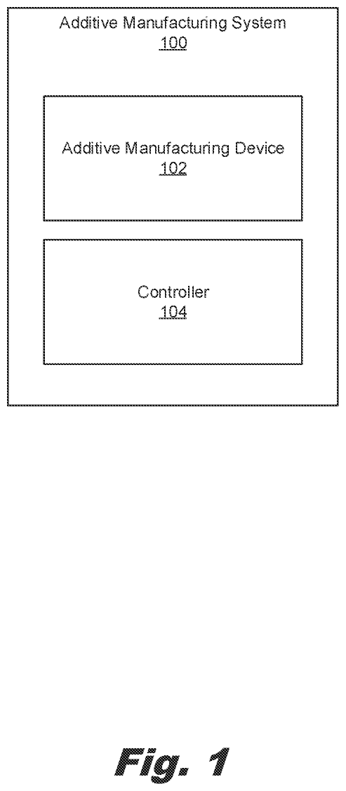

Turning now to the figures, FIG. 1 is a block diagram of an additive manufacturing system (100) for forming 3D printed objects with regions of differing porosity, according to an example of the principles described herein. The additive manufacturing system (100) includes an additive manufacturing device (102) to form a three-dimensional (3D) printed object with regions of differing porosity. As described above, a 3D printed object may be formed using any variety of additive manufacturing devices (102) including a binding-agent based system where a “green” part is passed to a sintering device to sinter particles together. The additive manufacturing device (102) may also be non-agent-based systems such as a selective laser sintering device, a selective laser melting device, a fused deposition modelling device, and a stereolithographic device. In general, apparatuses for generating three-dimensional objects may be referred to as additive manufacturing devices (102). The additive manufacturing devices (102) described herein may correspond to three-dimensional printing systems, which may also be referred to as three-dimensional printers.

The additive manufacturing system (100) also includes a controller (104) to form the 3D printed object. The controller (104) may include various hardware components, which may include a processor and memory. The processor may include the hardware architecture to retrieve executable code from the memory and execute the executable code. As specific examples, the controller as described herein may include computer readable storage medium, computer readable storage medium and a processor, an application specific integrated circuit (ASIC), a semiconductor-based microprocessor, a central processing unit (CPU), and a field-programmable gate array (FPGA), and/or other hardware device.

The memory may include a computer-readable storage medium, which computer-readable storage medium may contain, or store computer usable program code for use by or in connection with an instruction execution system, apparatus, or device. The memory may take many types of memory including volatile and non-volatile memory. For example, the memory may include Random Access Memory (RAM), Read Only Memory (ROM), optical memory disks, and magnetic disks, among others. The executable code may, when executed by the controller (104) cause the controller (104) to implement at least the functionality of interrupting printing and resuming printing as described below.

The controller (104) controls the additive manufacturing. That is, the controller (104) instructs the additive manufacturing device (102) to form the 3D printed object. Specifically, in a binding agent-based system, the controller (104) may direct a build material distributor to add a layer of build material. Further, the controller (104) may send instructions to direct a printhead of an agent distributor to selectively deposit the agent(s) onto the surface of a layer of the build material. The controller (104) may also direct the printhead to eject the agent(s) at specific locations to form a 3D printed object slice.

As describe above, formation of the 3D printed object includes forming regions of differing porosity. That is, a first region may be formed, which first region is porous. That is fluid may readily pass through the first porous region. A second region may be formed, which second region is non-porous. That is, fluid may not flow through this second region. The different regions of porosity may be formed by depositing different binding agents in the different regions. For example, a first binding agent may be deposited in both the porous region and the non-porous region while a second binding agent may be deposited in those regions of the 3D printed object that are to be non-porous. In this example, both binding agents bind powder build material particles together such that the green 3D printed object may be transferred to a sintering furnace. However, the second binding agent melts at a lower temperature than the first binding agent. Accordingly, the particles in the second binding agent melt and fill gaps between the powder build particles at a lower temperature. As such, sintering may be performed at a temperature between the melting temperature of the second binding agent and the first binding agent. In so doing, particles in the second binding agent melt and sinter between particles of the powder build material while the particles of the first binding agent neither melt nor fill in between particles of the powder build material. Accordingly, in the regions with just the first binding agent, there remain spaces between powder build particles such that fluid may pass therethrough.

The controller (104) controls the formation of the 3D printed object by 1) controlling ejection of a first binding agent in both the areas that are to form the porous regions and the areas that are to form the non-porous regions of the 3D printed object and 2) controlling ejection of a second binding agent in the areas that are to form the non-porous regions of the 3D printed object. That is, the controller (104) may send activation signals to ejectors of the agent distribution systems for each binding agent to eject fluid in particular patterns that correspond with the respective porous and non-porous regions.

In an example, the controller (104) also controls deposition of the build material that is to form the 3D object and onto which the binding agents are to be ejected. The powder build material may be of a variety of types including metal powder. In one particular example, for example for a 3D printed object used for heat transfer, the powder build material may be a copper powder build material.

In addition to the controlling binding agent ejection and build material deposition, the controller (104) may also select sintering characteristics so as to melt particles in the second binding agent without melting particles in the first binding agent. That is, as demonstrated above, particles in the respective first binding agent and second binding agent may respond differently to different sintering energies. Accordingly, the controller (104) monitors and selects sintering characteristics such that the particles in the second binding agent melt and sinter while those in the first binding agent remain in particulate form and therefore do not fill any space between the powder build material particles. In other words, the higher the sintering temperature, the greater the degree of sintering of the second binding agent, thus reducing the porosity in the porous regions. Put another way, as the sintering temperature and/or time increases, the density of the region increases while the porosity decreases. Accordingly, the controller (104) may select a sintering time and/or a sintering temperature such that the energy absorbed in the additive manufacturing bed is sufficient to melt particles in the second binding agent while preserving the first binding agent in particulate form.

A particular example of the formation of a 3D printed object with regions of differing porosity is now presented. In this example, the build material was copper powder having particles with a diameter of less than 50 micrometers. The build material was deposited using a supply lift, descending build bed, and a recoating roller. Each layer of copper powder build material was 80 micrometers thick and patterned with a binding agent and then sintered. As described above, the green 3D printed objects are exposed to a sintering process resulting in the finished 3D printed object. During sintering, the green part undergoes a de-binding process to remove organic components in the binder followed by pore closure. After the de-bind stage, the part is left with voids in between particles in place of binder. Therefore, this provides an opportunity to tune the porosity by varying the sintering temperature and times.

In this particular example, the 3D printed object is a heat pipe formed in a layer-by-layer fashion using, as the first binding agent, copper nitrate, and as the second binding agent, silver nanoparticle ink. In this example, the silver nanoparticles had a diameter of approximately 100 nanoparticles. The desired porous wicking portion of the heat pipe was bonded using copper nitrate while the non-porous regions that were to have a water and airtight seal were printed using silver nanoparticle ink and copper nitrate. During additive manufacturing, the bed was kept between 70-90 degrees Celsius (C) during additive manufacturing.

The green heat pipe was then sintered at a temperature of 650 C for 30 minutes, which melted the silver nanoparticles forming a sealed body. By comparison, those parts of the heat pipe that did not have the silver nanoparticles disposed thereon did not form a solid body as the copper nitrate in those regions did not reach its melting temperature and was thus retained in a porous form. That is, as the sintering temperature was low, 650° C. for 30 min, the copper particles sintered to a reduced extent, resulting in a continuous porous structure. This continuous porous structure acts as the wicking structure in the heat pipe. Whereas the silver rich portions prevent pores from connecting with one another, thus forming the leak tight walls of the heat pipe.

In an example, a sintering temperature of 450 C and above may result in silver nanoparticles that melt or sinter at the copper particle boundaries and completely occupied the void spaces. Sintering at 650° C.-30 min will have to 58% of theoretical density. The silver network surrounds the copper particles to 1) act as sealant and to 2) bind the copper particles together providing the strength to the 3D printed object.

While particular reference is made to sintering at a particular temperature for a particular amount of time, i.e., 650 C for 30 minutes, the 3D object may be sintered at different temperatures and/or times with different sintering characteristics resulting in different sintering densities. An example range includes between 450 C and 750 C.

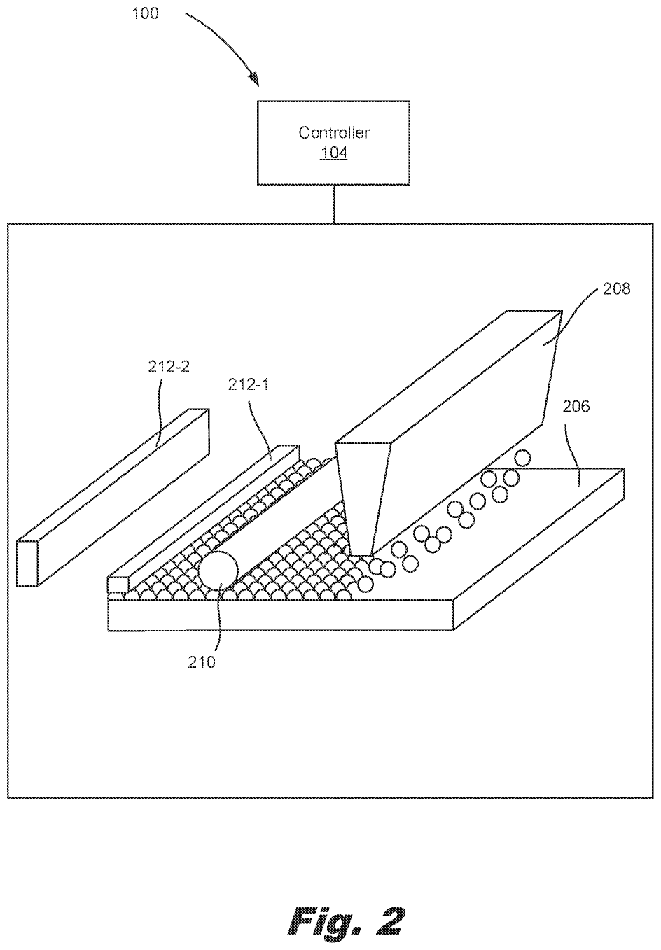

FIG. 2 is a diagram of an additive manufacturing system (FIG. 1, 100) for forming 3D printed objects with regions of differing porosity, according to an example of the principles described herein. As described above, the additive manufacturing system (FIG. 1, 100) may be a binding-agent based device, or other type of device. While FIG. 2 depicts a specific example of an agent-based device, the additive manufacturing device may be any of the above-mentioned devices or another type of additive manufacturing device.

In an example of an additive manufacturing process, a layer of build material may be formed in a build area. As used in the present specification and in the appended claims, the term “build area” refers to an area of space wherein the 3D printed object is formed. The build area may refer to a space bounded by a bed (206) and walls. The build area may be defined as a three-dimensional space in which the additive manufacturing device (FIG. 1, 102) can fabricate, produce, or otherwise generate a 3D printed object. That is, the build area may occupy a three-dimensional space on top of the bed (206) surface. For simplicity, the walls of the additive manufacturing device (FIG. 1, 102) have been removed to illustrate other components. In one example, the width and length of the build area can be the width and the length of bed (206) and the height of the build area can be the extent to which bed (206) can be moved in the z direction. Although not shown, an actuator, such as a piston, can control the vertical position of bed (208).

The bed (206) may accommodate any number of layers of build material. For example, the bed (206) may accommodate up to 4,000 layers or more. In an example, a number of build material supply receptacles may be positioned alongside the bed (206). Such build material supply receptacles source the build material that is placed on the bed (206) in a layer-wise fashion.

FIG. 2 clearly depicts the build material distributor (208). The build material distributor (208) may acquire build material from build material supply receptacles, and deposit acquired material as a layer in the bed (206), which layer may be deposited on top of other layers of build material already processed that reside in the bed (206). Each layer of the build material that is bound in the bed (206) forms a slice of the 3D printed object such that multiple layers of bound build material form the entire 3D printed object.

In some examples, the build material distributor (208) may be coupled to a scanning carriage. In operation, the build material distributor (208) places build material in the build area as the scanning carriage moves over the build area along the scanning axis. In some examples, the additive manufacturing device includes a roller (210) or other component to smooth and level the build material. As described above, the build material may be of a variety of types. In one particular example, the powder build material is a copper powder build material. In such an example, the 3D printed object may be a heat exchanger such as a heat pipe or a vapor chamber.

FIG. 2 also depicts agent distributors (212-1, 212-2) which form the 3D printed object. The agent distributors (212) do so by depositing at least one agent onto a layer of powdered build material. In this specific example, the binding agents may be selectively distributed on the layer of build material in a pattern of a layer of a 3D printed object. Each of the agent distributors (212) may deposit a different agent. For example, the first agent distributor (212-1) may distribute a first binding agent across both non-porous and porous regions of the 3D printed object. By comparison, the second agent distributor (212-2) may distribute a second binding agent across the portions of the build area (206) that are to form the non-porous regions of the 3D printed object.

In a particular example, the second binding agent includes a component that melts at a lower temperature than a component of the first binding agent. As such, those regions that have the second binding agent deposited thereon form a solid mass due to particles of the second binding agent fusing between holes in the powder build material. In a particular example, the first binding agent is copper nitrate. The second binding agent by comparison may be a metallic nanoparticle agent. For example, the second binding agent may be a silver nanoparticle agent. While silver is described as one particular metallic compound in the second binding agent, a variety of other metallic nanoparticles may be used in the second binding agent. Examples includes, aluminum, arsenic, beryllium, cadmium, cobalt, iron, manganese, magnesium, nickel, tin, silicon, tellurium, lead, phosphorous, and zinc, among others.

In some examples, the agent distributors (212) include at least one liquid ejection device to distribute a respective agent onto the layers of build material. A liquid ejection device may include at least one printhead (e.g., a thermal ejection based printhead, a piezoelectric ejection based printhead, etc.). In some examples, the agent distributors (212) are coupled to a scanning carriage, and the scanning carriage moves along a scanning axis over the bed (206). In one example, printheads that are used in inkjet printing devices may be used in the agent distributor (212). In this example, the fusing agent may be a printing liquid. In other examples, an agent distributor (212) may include other types of liquid ejection devices that selectively eject small volumes of liquid.

FIG. 2 also depicts the controller (104) which as described above determines the porous and non-porous regions of the 3D printed object and sends instructions to the additive manufacturing device (FIG. 1, 102) to form the 3D printed objects.

In the additive manufacturing process, a first binding agent is deposited on the layer of build material in a pattern that corresponds to a porous region and a non-porous region of a slice of the 3D printed object. Similarly, a second binding agent is deposited on the layer of build material in a pattern that corresponds to the non-porous region of a slice of the 3D printed object. Additional layers may be formed and the operations described above may be performed for each layer to thereby generate a green 3D printed object. The layer-by-layer formation of a 3D printed object may be referred to as a layer-wise additive manufacturing process. The green object may then be taken to a sintering furnace where it is sintered as described above.

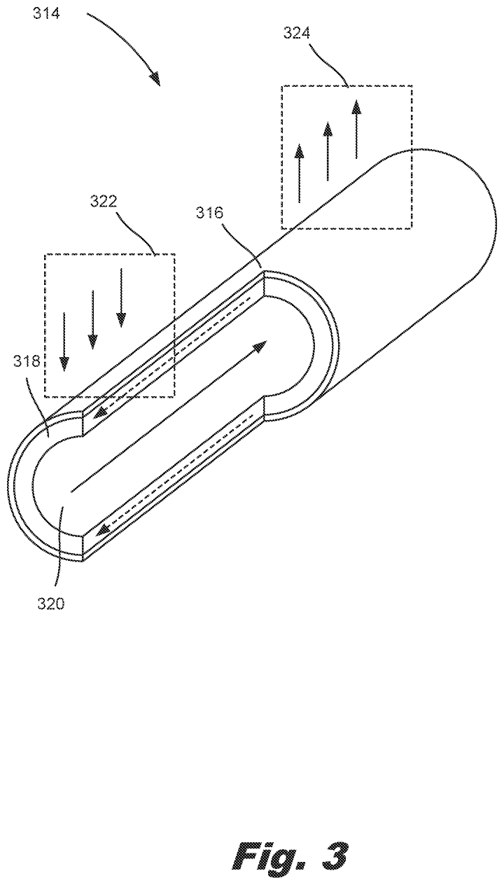

FIG. 3 is an example of a 3D printed heat pipe (314) with regions (316, 318) of differing porosity, according to an example of the principles described herein. As described above, a variety of 3D printed objects with regions of differing porosity may be formed by the additive manufacturing system (FIG. 1, 100) described above. One specific example of such a system is when the 3D printed object is a heat pipe (314). The heat pipe (314) includes an outer tube defining the non-porous region (316). The outer tube is lined with a wicking structure. The wicking structure defines the porous region (318) of the heat pipe (314). Using the methods and systems described herein, the heat pipe (314) may be formed by depositing a powder build material, and then depositing the second binding agent on just those areas that are to form the non-porous region (316), while a first binding agent is deposited on both the areas to form the non-porous region (316) and the porous region (318). As described, the 3D printed heat pipe may include a channel which is then filled with a working fluid such as water and vacuum sealed. This sealing procedure may be done by brazing a lid into place. While particular reference is made to water as a working fluid, the working fluid may be a low boiling temperature fluid, such as methanol for example, that is at atmospheric pressure. Due to its thermal conductivity, the powder build material used to form the heat pipe (314) may be a copper powder build material. Operation of a 3D printed copper heat pipe (314) is now described.

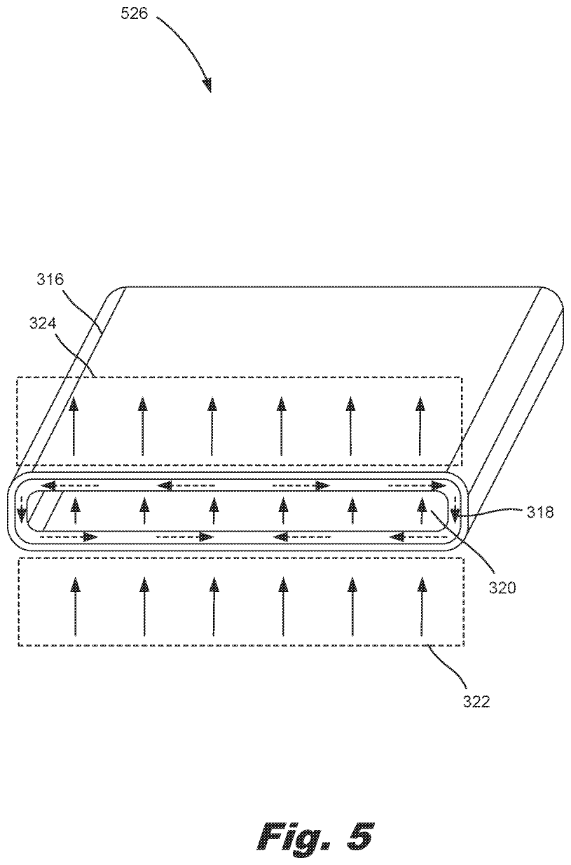

The heat pipe (314) is a device to spread and transfer heat from a hot region (322) to a cold region (324). In the example depicted in FIG. 3, the heat pipe (314) is a tubular device with a wicking structure, defined as a porous region (318) which is adjacent an outer tube, defined as a non-porous region (316). A channel (320) of the heat pipe (314) is filled with a working fluid, such as de-ionized water and sealed under partial vacuum. The vacuum causes the de-ionized water to evaporate at lower temperatures in the hot region (322) where heat energy is applied (evaporator). The water vapor then passes through the channel (320) of the heat pipe (314) to the cold region (324) where heat is removed (condenser). The condensed water is then transported back to the hot region (322) through the porous region (318) by capillary action. The capillary pressure is to overcome a liquid pressure drop (resistance to the flow of condensate back to the hot region (322)), vapor pressure drops (resistance to vapor flow from evaporator to condenser), and gravitation pressure. As described above, in another example, the working fluid is a low boiling temperature fluid, such as methanol. In this example, the working fluid is not under pressure, but is rather used at atmospheric pressure. While FIG. 3 depicts a particular geometry for the 3D printed heat pipe (314), heat exchangers may be formed with any variety of geometries, such as those depicted in FIGS. 5-7.

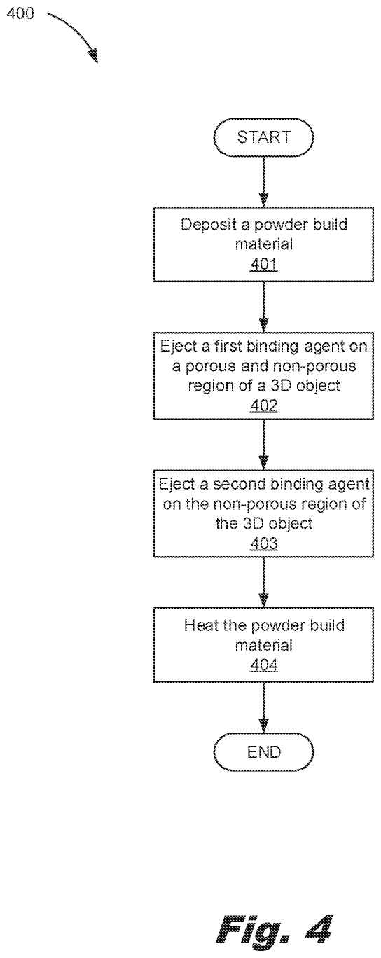

FIG. 4 is a flow chart of a method (400) for forming 3D printed objects with regions (316, 318) of differing porosity, according to an example of the principles described herein. As described above, additive manufacturing involves the layer-wise deposition of build material and sintering of certain portions of that layer to form a slice of a 3D printed object. Accordingly, in this example, the method (400) includes sequentially forming slices of a 3D printed object with regions of differing porosity. In some examples, this includes sequentially depositing (block 401) layers of a powder build material and ejecting binding agents to form the non-porous (FIG. 3, 316) and porous (FIG. 3, 318) regions of the 3D printed object. This includes sequential activation, per slice, of a build material distributor (FIG. 2, 208) and agent distributors (FIG. 2, 212) and the scanning carriages to which they may be coupled so that each distribute its respective composition across the surface.

Specifically, the additive manufacturing device (FIG. 1, 100) ejects (block 402) a first binding agent on portions of the build material that are to form the 3D printed object. As described above, the first binding agent may be deposited on those regions of the 3D printed object that are to be porous regions (FIG. 3, 318) and those regions of the 3D printed object that are to be non-porous regions (FIG. 3, 316). The first binding agent serves to semi-permanently bind portions of the build material together that are to form the 3D printed object to such a degree that the “green” 3D printed object may be removed and transported to a sintering furnace where the green 3D printed object is further heated to produce a fully hardened 3D printed object.

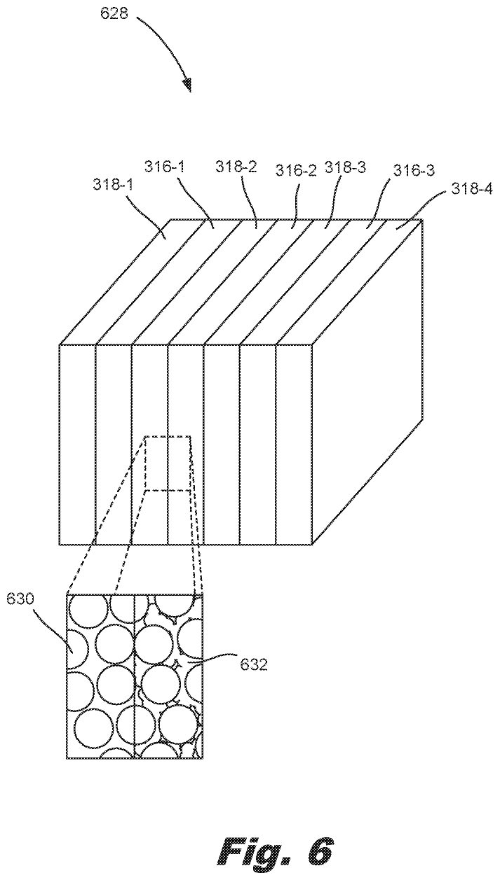

A second binding agent is ejected (block 403) to form the non-porous regions (FIG. 3, 316) of the 3D printed object. This second binding agent may have a lower melt temperature than the first binding agent such that upon heating to a temperature between the melting temperature of the first and second binding agent, the second binding agent melts and fills gaps between powder build material particles. At this temperature however, particles in the first binding agent do not melt and therefore the gaps in the powder build material particles remain. FIG. 6 depicts an example of the porous regions (FIG. 3, 318) and non-porous regions (FIG. 3, 316).

According to the method (400), the powder build material is heated (block 404) to a temperature between the melting temperature of particles in the second binding agent and a melting temperature of particles in the first binding agent. For example, the melting temperature of the particles in the first binding agent may be 750 C where the melting temperature of the particles in the second binding agent may be 450 C. Accordingly, by heating (block 404) the build material to a temperature of 650 C, particles in the first binding agent do not melt whereas particles in the second binding agent do melt. Thus, regions of the 3D printed object that have the second binding agent thereon form a solid, or non-porous region (FIG. 3, 316), while other regions of the 3D printed object are porous on account of the first binding agent not melting to fill build material gaps.

In some examples, the instructions to heat (block 404) the build material may be calculated and output. That is, in an example, the additive manufacturing system (FIG. 1, 100) may generate a prompt to the user to input into a sintering oven or may be output directly by a sintering oven. The instructions to heat (block 404) the build material may be indicate the sintering time and/or temperature.

In some examples, within the porous region, the additive manufacturing system (FIG. 1, 100) may have regions of differing porosity. For example, in certain areas where there may be more heat generated, a greater porosity may be desired to enhance the heat transfer at this location. Accordingly, the additive manufacturing system (FIG. 1, 100) may increase the porosity of the porous region in this area while other areas may have a lower porosity, for example to enhance conduction of water towards this area of higher porosity.

Such a formation of areas of different porosity within the porous region may occur in a variety of ways. For example, different temperatures used during heating (block 404) may affect the degree to which the powder build material is sintered. As described above, the higher the sintering temperature, the greater the degree of sintering of the second binding agent, thus reducing the porosity in the porous regions. Put another way, as the sintering temperature and/or time increases, the density of the region increases while the porosity decreases.

In other examples, the loading of the binding agents may also be used to control porosity. For example, a higher loading of a binding agent may result in greater sintering which may result in less porosity.

In summary, in a particular example, the disclosed additive manufacturing system (FIG. 1, 100) uses copper nitrate ink and silver nanoparticle ink to bind powder build material to form green 3D printed objects. Low temperature sintering causes the silver nanoparticles to melt or sinter and occupy the interparticle spaces and intervene the connected porosity thus generating a closed pore structure, which may act as a sealed wall of a heat pipe (FIG. 3, 314).

The region of the 3D printed object that does not have the silver nanoparticles disposed thereon, is partially sintered leaving behind interconnected porosity that may serve as a wicking structure of a heat pipe (FIG. 3, 314). While specific mention is made of a 3D printed heat pipe (FIG. 3, 314), the method (400) may be used to form other thermal management device and/or heat pipes with geometries that were otherwise unavailable.

Note that in these examples one end of the 3D printed heat pipe (FIG. 3, 314) or other heat exchanger may remain open such that unbound build material may be removed. That is, as described above a heat pipe (FIG. 3, 314) includes a hollow channel (FIG. 3, 320). This hollow channel (FIG. 3, 320) may be formed by preventing deposition of any binding agent in this area. Accordingly, once sintered, the unbound powdered build material may be dumped out or otherwise removed, a working fluid introduced, and the heat pipe (FIG. 3, 314) sealed to provide the vacuum and operational mechanism of the heat transfer.

FIG. 5 is an example of a 3D printed vapor chamber (526) with regions (316, 318) of differing porosity, according to an example of the principles described herein. As described above, a variety of 3D printed objects with regions of differing porosity may be formed by the additive manufacturing system (FIG. 1, 100) described above. One specific example of such a system is when the 3D printed object is a vapor chamber (526). A vapor chamber (526) operates under the same principles as a heat pipe in that it transfers heat from a concentrated hot region (322) to a cold region (324) where a heat sink may be attached. The heat sink then dissipates the heat into the surrounding environment, thus allowing the vapor to condense and wick back towards the hot region (322). The vapor chamber (526) may include joined plates forming the non-porous region (316) which are lined with an inner wicking structure forming the porous region (318). Using the methods and systems described herein, the vapor chamber (526) may be formed by depositing a powder build material, and then depositing the second binding agent on just those areas that are to form the non-porous region (316), while a first binding agent is deposited on both the areas to form the non-porous regions (316) and the porous regions (318).

In an example, the vapor chamber (526) may be formed by building up the non-porous walls of the vapor chamber (526) using the first binding agent such as copper nitrate and a second binding agent such as silver nanoparticle ink. A lid may be formed over this hollow box structure to form the hollow vapor chamber (526).

As described, the 3D printed vapor chamber may include a channel which is then filled with a working fluid and vacuum sealed. This sealing procedure may be done by brazing a lid into place. While particular reference is made to water as a working fluid, the working fluid may be a low boiling temperature fluid, such as methanol for example, that is at atmospheric pressure. Due to its thermal conductivity, the powder build material used to form the vapor chamber (526) may be a copper powder build material.

FIG. 6 is a diagram of a 3D printed object (628) with regions (316, 318) of differing porosity, according to an example of the principles described herein. Specifically, FIG. 6 depicts an example with alternating bands of non-porous regions (316-1, 316-2, 316-3) and porous regions (318-1, 318-2, 318-3, 318-4). FIG. 6 also depicts a zoomed in representation of each region. As depicted, in the porous regions (318), powder build material particles (630) have gaps between them that remain following sintering. By comparison, in the non-porous regions (316), metallic nanoparticles (632) have melted and filled the gaps between the powder build material particles (630) thus resulting in a solid, or non-porous, watertight, and airtight mass.

While specific reference is made to 3D printed objects (628) with porous regions (318) lining non-porous regions (316), the systems and methods described herein may be used to form other types of devices. For example, the 3D printed object (628) may be a conformal cooler in an injection molding tool.

That is, the regions (316, 318) may be formed to match a contour of an object when more heat is to be extracted, for example when a tool generates a lot of heat that is to be removed for proper operation of the tool. Fluid may be run through the cooler to effectively cool the object, which may be an injection molding tool.

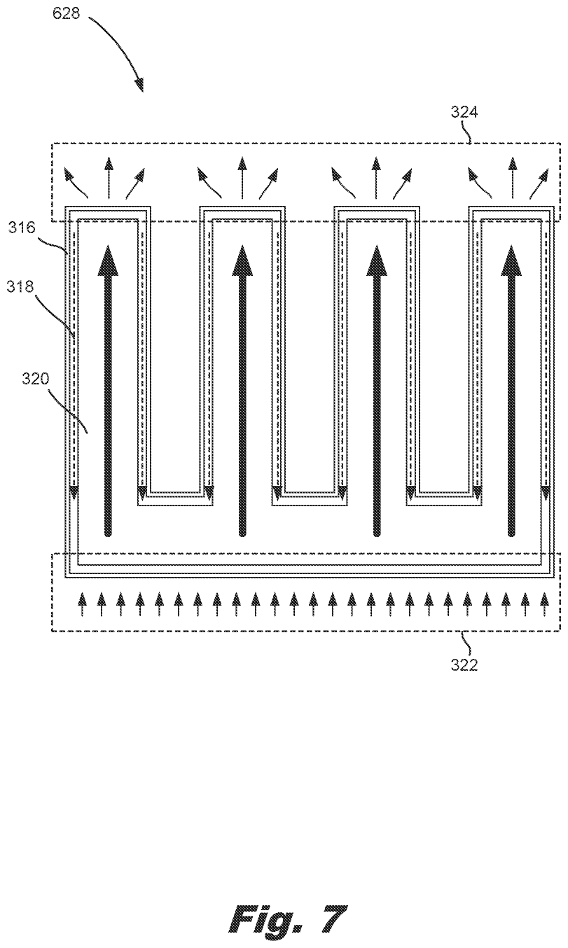

FIG. 7 is a diagram of a 3D printed object (628) with regions (316, 318) of differing porosity, according to an example of the principles described herein. As described above, 3D printing heat exchangers provides great flexibility in the geometries and form of a heat exchanger. That is, the systems and methods described herein allow, heat pipes (FIG. 3, 314), vapor chambers (FIG. 5, 526), and other 3D printed objects (628) to be formed with geometries that would otherwise be unable to be formed. As a particular example, the 3D printed object (628) may include a network of heat pipes (FIG. 3, 314) in a branching structure. As another example, FIG. 7 depicts a 3D printed object (628) which is a heat exchanger with fins extending from a surface.

As described above, in a hot region (322), a heated component may vaporize a working fluid. The vaporized fluid rises through the fins. The water vapor then passes through the hollow channels (320) of the fins to the cold region (324) where heat is removed via condensation. The condensed water is then transported back to the hot region (322) through the porous region (318) by capillary action and gravity. In the example depicted in FIG. 7, additional cooling is seen as air flow between the fins draws even more heat from the system and condenses the working fluid at a faster rate.

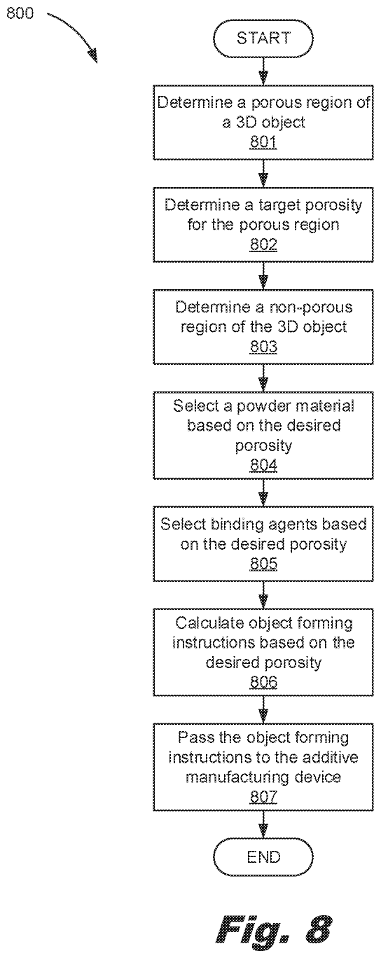

FIG. 8 is a flow chart of a method (800) for forming 3D printed objects (FIG. 6, 628) with regions (FIG. 3, 316, 318) of differing porosity, according to an example of the principles described herein.

According to the method (800), a porous region (FIG. 3, 318) for the 3D object (FIG. 6, 628) is determined (block 801). That is, when designing a particular 3D printed object (FIG. 6, 628), a user may indicate that a certain surface is to be porous. For example, the user may indicate that an inner lining of a hollow tube is to form a wicking structure of a heat pipe (FIG. 3, 314). In this example, the user may also define the dimensions of the porous region (FIG. 3, 318).

According to the method (800), a target porosity for the porous region (FIG. 3, 318) is also determined (block 802). That is, based on the application, working fluid, powder build material, etc., different porosities may be desired. As a particular example, the density of a wicking structure may impact its ability to remove heat. Accordingly, based on characteristics of the application, the additive manufacturing system (FIG. 1, 100) may determine (block 802) a target porosity, which target porosity may be received via user input. In another example, the additive manufacturing system (FIG. 1, 100) may determine (block 802) a target porosity based on other user input. For example, a user may input the application, working fluid, build material, etc. From this input, the additive manufacturing system (FIG. 1, 100) may determine (block 802) the target porosity.

A non-porous region (FIG. 3, 316) for the 3D printed object (FIG. 6, 628) is determined (block 803). Again, this may be done via user input, which user input may also indicate the dimensions and other properties of the non-porous region (FIG. 3, 316). As an example, the user may indicate that an outer tube of a heat pipe (FIG. 3, 314) is to be airtight, watertight, and non-porous.

In some examples, the powder build material is selected (block 804) based on a target porosity. For example, porosity is dependent upon the powder particle size. As a particular example, powder build material with fine particles (i.e., 1 micron to 20 microns) may pack more tightly and sinter to a greater degree as compared to coarse particles (i.e., 30 microns to 100 microns). Accordingly, at a same sintering temperature and sintering time, finer particles sinter more, creating less porous structure as compared to coarser particles. Accordingly, based on the target porosity, a particular powder build material may be selected (block 804).

Similarly, based on the determined target porosity, a first binding agent and second binding agent may be selected (block 805).

Object forming instructions may then be calculated (block 806) based on the target porosity. That is, the system may provide instructions to the additive manufacturing device (FIG. 1, 102) regarding which powder build material to deposit, which binding agents to use, how much binding agent to use, and where to deposit the respective binding agents to form the 3D printed object (FIG. 6, 628) as intended. Accordingly, the object forming instructions include a quantity of the first binding agent to eject and a quantity of a second binding agent to eject. The object forming instructions may also indicate where to deposit the first binding agent, i.e., those portions of the powder build material that are to form any part of the 3D printed object (FIG. 6, 628). The object forming instructions may also indicate where to deposit the second binding agent, i.e., those portions of the powder build material that are to form non-porous regions (FIG. 3, 316) of the 3D printed object (FIG. 6, 628).

In some examples, the object forming instructions may further indicate regions of heightened surface roughness of the porous region (FIG. 3, 318). In an example, the surface roughness may relate to a porosity with a heightened surface roughness indicating greater porosity, or greater size of the pore of the porous region. That is, the surface roughness may impact the rate at which a working fluid is evaporated. Accordingly, the object forming instructions may indicate where on the 3D printed object (FIG. 6, 628) a surface roughness should be altered. An example location may be the area of the porous region (FIG. 3, 318) that is adjacent the hot region (FIG. 3, 322).

Turning to the example of a vapor chamber (FIG. 5, 526). In some examples, the vapor chamber (FIG. 5, 526) may be placed over a heat-producing chip, which chip may have a smaller area than the vapor chamber (FIG. 5, 526). This may result in an area of increased heat transfer on top of the chip as compared to portions of the vapor chamber (FIG. 5, 526) that are not directly over the chip. Accordingly, in this example, the porosity of the porous region may vary. Specifically, the porosity of the porous region may be greater directly above the chip so as to increase the heat transfer from this region. For those portions of the vapor chamber (FIG. 5, 526) that are not directly over the chip, the porosity may be reduced to facilitate return of the condensate back to the hot region for continued heat removal. In other words, as described herein, the porosity of the porous region may vary to effectuate different rates of heat transfer.

Once calculated, the object forming instructions are passed (block 807) to the additive manufacturing device (FIG. 1, 102), such that the additive manufacturing device (FIG. 1, 102) may form the 3D printed object (FIG. 6, 628) with the desired porous (FIG. 3, 318) and non-porous regions (FIG. 3, 316).

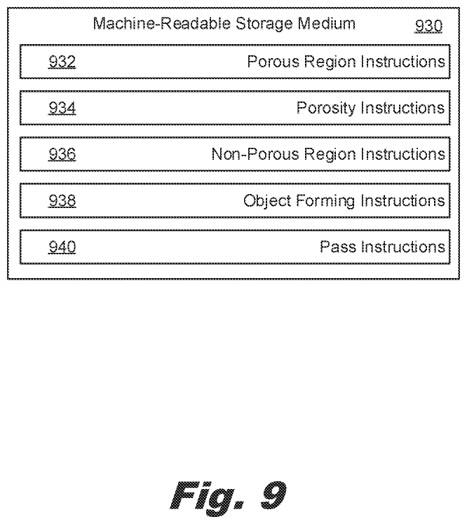

FIG. 9 depicts a non-transitory machine-readable storage medium (930) for forming 3D printed objects (FIG. 6, 628) with regions (FIG. 3, 316, 318) of differing porosity, according to an example of the principles described herein. To achieve its desired functionality, a controller (FIG. 1, 104) includes various hardware components. Specifically, the controller (FIG. 1, 104) includes a processor and a machine-readable storage medium (930). The machine-readable storage medium (930) is communicatively coupled to the processor. The machine-readable storage medium (930) includes a number of instructions (932, 934, 936, 938, 940) for performing a designated function. The machine-readable storage medium (930) causes the processor to execute the designated function of the instructions (932, 934, 936, 938, 940). The machine-readable storage medium (930) can store data, programs, instructions, or any other machine-readable data that can be utilized to operate the additive manufacturing system (FIG. 1, 100). Machine-readable storage medium (930) can store computer readable instructions that the processor of the controller (FIG. 1, 104) can process, or execute. The machine-readable storage medium (930) can be an electronic, magnetic, optical, or other physical storage device that contains or stores executable instructions. Machine-readable storage medium (930) may be, for example, Random Access Memory (RAM), an Electrically Erasable Programmable Read-Only Memory (EEPROM), a storage device, an optical disc, etc. The machine-readable storage medium (930) may be a non-transitory machine-readable storage medium (930).

Referring to FIG. 9, porous region instructions (926), when executed by the processor, cause the processor to determine a porous region (FIG. 3, 318) of a 3D object (FIG. 6, 628) to be printed. Porosity instructions (934), when executed by the processor, may cause the processor to determine a target porosity for the porous region (FIG. 3, 318). Non-porous region instructions (936), when executed by the processor, may cause the processor to determine a non-porous region (FIG. 3, 316) of the 3D object (FIG. 6, 628) to be printed. Object forming instructions (938), when executed by the processor, may cause the processor to calculate object forming instructions for an additive manufacturing device (FIG. 1, 102) to form the 3D object (FIG. 6, 628) based on the target porosity. The object forming instructions may indicate 1) a quantity of a first binding agent to eject in the porous region (FIG. 3, 318) and the non-porous region (FIGS. 3, 316) and 2) a quantity of a second binding agent to eject in the non-porous region (FIG. 3, 316) based on the target porosity. As described above, the first binding agent has a lower melting temperature than the second binding agent. Pass instructions (940), when executed by the processor, may cause the processor to pass the object forming instructions to the additive manufacturing device (FIG. 1, 102).

Such systems and methods 1) allow for printing of objects such as heat pipes and vapor chambers that have regions of differing porosity; 2) form such objects in a single printing cycle without assembly of a variety of complex components; 3) allow for geometrical customization of the porous region, non-porous region, and overall heat exchanger; and 4) allows for enhanced capillary pressure, capacity, and boiling performance through customized geometries. However, it is contemplated that the systems and methods disclosed herein may address other matters and deficiencies in a number of technical areas.

What is claimed is:

1. An additive manufacturing system, comprising:
an additive manufacturing device to form a three-dimensional (3D) printed object with regions of differing porosity; and
a controller to form the 3D printed object by:
controlling ejection of a first binding agent on a porous region and a non-porous region of the 3D printed object; and
controlling ejection of a second binding agent on the non-porous region of the 3D printed object.

2. The additive manufacturing system of claim 1, wherein the second binding agent comprises a component that melts at a lower temperature than a component of the first binding agent.

3. The additive manufacturing system of claim 1, wherein the first binding agent comprises copper nitrate.

4. The additive manufacturing system of claim 1, wherein the second binding agent comprises a metallic nanoparticle agent.

5. The additive manufacturing system of claim 1, wherein the controller is to control deposition of a copper powder build material onto which the binding agents are to be ejected.

6. The additive manufacturing system of claim 1, wherein the controller is to select sintering characteristics so as to melt particles in the second binding agent without melting particles in the first binding agent and a powder build material.

7. The additive manufacturing system of claim 6, wherein the sintering characteristics comprise a sintering time and a sintering temperature.

8. A method, comprising:
forming slices of a three-dimensional (3D) printed object with regions of differing porosity by sequentially:
depositing a powder build material;
ejecting a first binding agent onto a porous region and a non-porous region of the 3D printed object;
ejecting a second binding agent onto the non-porous region of the 3D printed object; and
heating the powder build material to a temperature between a melting temperature of particles in the second binding agent and a melting temperature of particles in the first binding agent.

9. The method of claim 8, wherein:
the 3D printed object comprises a heat pipe; and
the heat pipe comprises an outer tube forming the non-porous region lined with a wicking structure forming the porous region.

10. The method of claim 8, wherein:
the 3D printed object comprises a vapor chamber; and
the vapor chamber comprises joined plates forming the non-porous region lined with a wicking structure forming the porous region.

11. The method of claim 8, wherein the powder build material is a copper powder build material.

12. A non-transitory machine-readable storage medium encoded with instructions executable by a processor, the machine-readable storage medium comprising instructions to:
determine a porous region of a three-dimensional (3D) object to be printed;
determine a target porosity for the porous region;
determine a non-porous region of the 3D object to be printed;
calculate object forming instructions for an additive manufacturing device to form the 3D object based on the target porosity, wherein the object forming instructions indicate:
a quantity of a first binding agent to eject in the porous region and the non-porous region; and
a quantity of a second binding agent to eject in the non-porous region based on the target porosity, wherein the first binding agent has a lower melting temperature than the second binding agent; and
pass the object forming instructions to the additive manufacturing device.

13. The non-transitory machine-readable storage medium of claim 12, wherein the object forming instructions further indicate a region of heightened surface roughness of the porous region.

14. The non-transitory machine-readable storage medium of claim 12, wherein the instructions are executable by the processor to select a powder material to deposit based on the target porosity.

15. The non-transitory machine-readable storage medium of claim 12, wherein the instructions are executable by the processor to select the first binding agent and the second binding agent based on the target porosity.
